(19) United States
(12) Patent Application Publication
(10) Pub. No.: US 2006/0014029 A1
(43) Pub. Date: Jan. 19, 2006

(54) Article including environmental barrier coating system, and method for making

(75) Inventors: Jennifer Su Saak, Clifton Park, NY (US); Peter Joel Meschter, Niskayuna, NY (US); Krishan Lal Luthra, Niskayuna, NY (US); Reza Sarrafi-Nour, Clifton Park, NY (US); Richard Didomizio, Latham, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 10/892,682

(22) Filed: Jul. 15, 2004

(51) Int. Cl. B32B 13/04

(52) U.S. Cl. 428/446; 427/402; 428/702

(57) ABSTRACT

Articles for use in a high temperature environment, and methods for protecting articles in such environments, are provided. The article comprises a substrate comprising silicon; a bondcoat comprising silicon, disposed over the substrate; an intermediate barrier disposed over the bondcoat, the barrier comprising at least one layer, wherein the at least one layer comprises a rare-earth silicate and is substantially free of mullite; and a topcoat disposed over the intermediate barrier, the topcoat comprising a rare-earth monosilicate. The method comprises providing a substrate, the substrate comprising silicon; disposing a bondcoat comprising silicon over the substrate; disposing an intermediate barrier over the bondcoat, the barrier comprising at least one layer, wherein the at least one layer comprises a rare-earth silicate and is substantially free of mullite; and disposing a topcoat over the intermediate barrier, the topcoat comprising a rare-earth monosilicate.

### BACKGROUND OF THE INVENTION

This invention relates to high-temperature machine components. More particularly, this invention relates to coating systems for protecting machine components from exposure to high-temperature environments. This invention also relates to methods for protecting articles.

Silicon-bearing materials, such as, for example, ceramics, alloys, and intermetallics, offer attractive properties for use in structures designed for service at high temperatures in such applications as gas turbine engines, heat exchangers, and internal combustion engines, for example. However, the environments characteristic of these applications often contain water vapor, which at high temperatures is known to cause significant surface recession and mass loss in silicon-bearing materials. The water vapor reacts with the structural material at high temperatures to form volatile silicon-containing species, often resulting in unacceptably high recession rates.

Environmental barrier coatings (EBC's) are applied to silicon-bearing materials susceptible to attack by high temperature water vapor, and provide protection by prohibiting contact between the water vapor and the surface of the material. EBC's are designed to be relatively stable chemically in high-temperature, water vapor-containing environments and to minimize connected porosity and vertical cracks, which provide exposure paths between the material surface and the environment. Cracking is minimized in part by minimizing the thermal expansion mismatch between the EBC and the underlying material, and improved adhesion and environmental resistance can be achieved through the use of multiple layers of different materials. One exemplary conventional EBC system, as described in U.S. Pat. No. 6,410,148, comprises a silicon or silica bond layer applied to a silicon-bearing substrate; an intermediate layer comprising mullite or a mullite-alkaline earth aluminosilicate mixture deposited over the bond layer; and a top layer comprising an alkaline earth aluminosilicate deposited over the intermediate layer. In U.S. Pat. No. 6,296,941, the above bond layer and intermediate layers are used, but the top layer is a yttrium silicate layer rather than an aluminosilicate.

Although the above coating systems provide suitable protection to substrates at temperatures of up to about 1200° C., advances in the design of gas turbine and other high-temperature equipment require materials to endure long term exposures at even higher temperatures. Therefore, there is a need to provide articles protected by environmental barrier coating systems having the capability to withstand long term exposure to high temperature environments containing water vapor. Moreover, there is a further need to provide methods for protecting articles from such high-temperature environments.

### BRIEF DESCRIPTION

Embodiments of the present invention are provided to address this and other needs. One embodiment is an article for use in a high temperature environment. The article comprises a substrate comprising silicon; a bondcoat comprising silicon, disposed over the substrate; an intermediate barrier disposed over the bondcoat, the barrier comprising at least one layer, wherein the at least one layer comprises a rare-earth silicate and is substantially free of mullite; and a topcoat disposed over the intermediate barrier, the topcoat comprising a rare-earth monosilicate.

A second embodiment of the present invention is a method for protecting an article from a high temperature environment. The method comprises providing a substrate, the substrate comprising silicon; disposing a bondcoat comprising silicon over the substrate; disposing an intermediate barrier over the bondcoat, the barrier comprising at least one layer, wherein the at least one layer comprises a rare-earth silicate and is substantially free of mullite; and disposing a topcoat over the intermediate barrier, the topcoat comprising a rare-earth monosilicate.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIGS. 1, 2, and 3 are cross-sectional schematics of embodiments of the present invention.

### DETAILED DESCRIPTION

Advanced designs for gas turbines and other high-temperature equipment require components to withstand exposures of thousands, or tens of thousands, of hours to temperatures in excess of 1300° C., representing a significant increase in the aggressiveness of the environment for which conventional EBC systems were originally designed. The present inventors have found that exposure to these higher temperatures tends to unacceptably degrade the performance of conventional EBC systems. Identified causes for the degradation at temperatures at or above 1300° C. include (1) a high reaction rate between the aluminosilicate topcoat and the water vapor contained in the gaseous environment, leading to an unacceptably high recession rate of the topcoat; and (2) substantial chemical interaction between the mullite-aluminosilicate intermediate layer and the silicon bond layer, leading to accelerated consumption of the bond layer and swelling and cracking at the bond layer/intermediate layer interface. Embodiments of the present invention address at least these two sources of degradation.

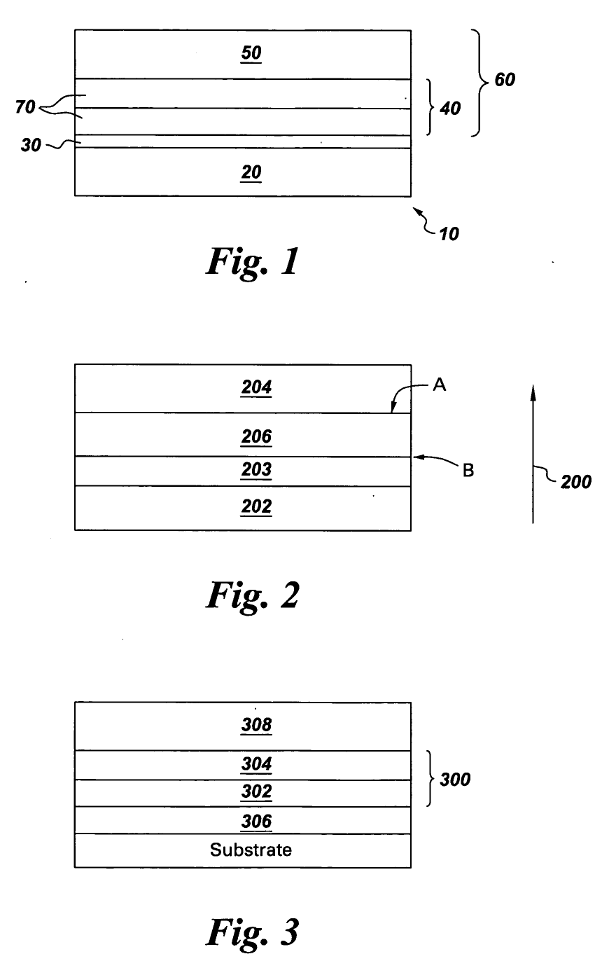

Referring to FIG. 1, one embodiment of the present invention is an article 10 for use in a high-temperature environment comprising a substrate 20 comprising silicon. In certain embodiments, substrate 20 comprises at least one of silicon nitride, molybdenum disilicide, and silicon carbide. One particularly suitable substrate material is a ceramic matrix composite material comprising a silicon carbide matrix reinforced with fibers comprising silicon carbide, although other combinations of silicon-bearing ceramic matrix material and fiber reinforcement material are suitable as well. In particular embodiments of the present invention, substrate 20 comprises a component of a gas turbine engine, such as, for example, a combustion liner, shroud, or an airfoil component such as a nozzle or blade.

A bondcoat 30 comprising silicon is disposed over substrate 20 to enhance the adhesion and barrier properties of the EBC system 60. Bondcoat 30, in certain embodiments, comprises at least one of elemental silicon (such as, for example, a substantially pure silicon layer), silica, and a silicide. The thickness selected for the bondcoat 30 will depend on a number of factors, including, for example, the particular substrate material to be protected, the temperature and other environmental conditions to be endured, and the expected service life of the coating. In particular embodiments, bondcoat 30 has a thickness in the range from about 25 micrometers to about 200 micrometers.

An intermediate barrier 40 comprising at least one layer 70 is disposed over bondcoat 30. The intermediate barrier 40 enhances the performance of the coating system by providing a barrier to water vapor exposure of substrate 20 and by providing a transition in chemical composition and thermal expansion coefficient between substrate 20 and topcoat 50. Each layer 70 of intermediate barrier 40 comprises, and in some embodiments consists essentially of, a rare-earth silicate. As used herein, “rare-earth silicate” means chemical compounds that comprise any of the silicate species, such as, for example, monosilicate, disilicate, orthosilicate, metasilicate, polysilicate, apatite phase, and the like, and one or more rare-earth elements. “Rare-earth elements”, as used herein, include scandium, yttrium, and any element or elements from the lanthanide series (atomic numbers 57-71). Additionally, each layer 70 of intermediate barrier 40 is substantially free of mullite. Removing mullite from layer 70 enhances the stability of the coating system at high temperatures. Mullite is not chemically stable in contact with some rare earth silicates, such as, for example, yttrium monosilicate, at the desired temperature range for these articles. Moreover, removing mullite from rare-earth silicate coatings reduces the activity of silica in the coating, which reduces the propensity of the coating to react with water vapor and to interact with the silicon bond layer.

In certain embodiments, the rare-earth silicate is a (meaning at least one) rare-earth monosilicate (RE₂SiO₅, where RE signifies at least one rare-earth element), a (meaning at least one) rare-earth disilicate (RE₂Si₂O₇), or a combination of these. Examples of suitable rare-earth monosilicates include lutetium monosilicate, ytterbium monosilicate, yttrium monosilicate, and combinations thereof. Examples of suitable rare-earth disilicates include lutetium disilicate, ytterbium disilicate, yttrium disilicate, and combinations thereof.

In particular embodiments, barrier 40 comprises a single layer. The single layer in certain embodiments comprises a compositional gradient. In an exemplary embodiment of this type (FIG. 2), a concentration of rare-earth monosilicate in the single layer 206 increases as a function of distance in a direction 200 moving from point A to point B, that is, a direction generally moving away from substrate 202 and bondcoat 203, moving toward the topcoat 204. This particular “graded layer” embodiment provides a gradual transition in coefficient of thermal expansion, thereby reducing thermal stresses among the various layers in the system. In particular embodiments, layer 206 further comprises a rare-earth disilicate.

In alternatives to the single-layer intermediate barrier embodiments, barrier 300 comprises a plurality of layers 302, 304 (FIG. 3). In certain embodiments, barrier 300 comprises a first layer 302 disposed over bondcoat 306 and a second layer 304 disposed over first layer 302 and under topcoat 308. First layer 302 comprises, and in some embodiments consists essentially of, a rare-earth disilicate. Under service conditions, a layer of silicon oxide forms on the bondcoat 306. Rare-earth disilicates are thermodynamically stable in the presence of this silicon oxide layer, and so this embodiment promotes high-temperature chemical stability by having disilicate in contact with bondcoat 306. Second layer 304 comprises, and in some embodiments consists essentially of, a rare-earth monosilicate and a rare-earth disilicate, thereby providing a transition in composition and thermal expansion coefficient between first layer 302 and topcoat 308. Second layer 304 is a simple mixture of the monosilicate and disilicate materials in some embodiments, and in alternative embodiments comprises a compositional gradient as described above for single layer 206 (FIG. 2).

Regardless of whether barrier 40 (FIG. 1) comprises a single layer or a plurality of layers, its composition is controlled to ensure that thermal mismatch stresses between coating system 60 and substrate 20 are not unacceptably high. This is accomplished by controlling the thermal expansion coefficient and thickness of barrier 40. By keeping the thermal expansion coefficient of barrier 40 close to that of substrate 20, stresses are maintained at acceptable levels. In certain embodiments, a difference between the coefficient of thermal expansion of substrate 20 and that of each layer 70 of barrier 40 is up to about 3.0×10⁻⁶ ° C.⁻¹. In particular embodiments, this difference is up to about 0.5×10⁻⁶ ° C.⁻¹. The thickness of barrier 40 is selected based on a balance of competing factors. For example, as thickness increases, the probability that the coating will vaporize completely in a water vapor bearing combustion environment over a given time period decreases, but the tendency of the coating to crack or spall increases. In some embodiments, each layer 70 of barrier 40 has a thickness of up to about 250 micrometers. In certain embodiments, this thickness is in the range from about 25 micrometers to about 125 micrometers, and in particular embodiments the thickness is in the range from about 25 micrometers to about 75 micrometers.

Article 10 (FIG. 1) further comprises a topcoat 50 disposed over intermediate barrier 40. Topcoat 50 serves as the primary barrier between the environment and substrate 20, and therefore is selected to have high resistance to water vapor. Accordingly, topcoat 50 in embodiments of the present invention comprises, and in some embodiments consists essentially of, a rare-earth monosilicate, such as, for example, lutetium monosilicate, ytterbium monosilicate, yttrium monosilicate, and combinations thereof. Rare-earth monosilicates have been found to possess recession resistance superior to that of conventional EBC topcoat materials, such as aluminosilicates, in water vapor-bearing combustion environments. The thickness of topcoat 50 is selected based on a balance of similar factors to those described above for intermediate barrier 40. In some embodiments, the thickness of topcoat 50 is up to about 750 micrometers. In certain embodiments, this thickness is in the range from about 25 micrometers to about 125 micrometers, and in particular embodiments the thickness is in the range from about 25 micrometers to about 75 micrometers.

Those skilled in the art will appreciate that several specific embodiments are encompassed by the article of the present invention. One specific embodiment is an article comprising a substrate comprising silicon; a bondcoat comprising silicon disposed over the substrate; an intermediate barrier, the barrier substantially free of mullite and comprising
a. a first layer disposed over the bondcoat and comprising at least one of lutetium disilicate, ytterbium disilicate, yttrium disilicate, and combinations thereof, and
b. a second layer disposed over the first layer, the second layer comprising at least one of lutetium disilicate, ytterbium disilicate, yttrium disilicate, and combinations thereof, and further comprising at least one of lutetium monosilicate, ytterbium monosilicate, yttrium monosilicate, and combinations thereof; and
a topcoat disposed over the intermediate barrier, the topcoat comprising at least one of lutetium monosilicate, ytterbium monosilicate, yttrium monosilicate, and combinations thereof. In this embodiment the first layer of the intermediate barrier comprises disilicate, which is highly stable in contact with the silicon oxide that generally forms on the bondcoat in service, as discussed above. The second layer of the intermediate barrier provides a transition from the disilicate first layer to the highly recession-resistant monosilicate of the top layer, helping to reduce thermal stresses between the EBC system and the substrate.

A second specific embodiment is an article for use in a high temperature environment, comprising a substrate comprising silicon; a bondcoat comprising silicon, the bondcoat disposed over the substrate; an intermediate barrier disposed over the bondcoat, the barrier comprising at least one layer, wherein the at least one layer is substantially free of mullite and comprises lutetium disilicate, ytterbium disilicate, yttrium disilicate, and combinations thereof, and further comprises at least one of lutetium monosilicate, ytterbium monosilicate, yttrium monosilicate, and combinations thereof; and a topcoat disposed over the barrier layer, the topcoat comprising at least one of lutetium monosilicate, ytterbium monosilicate, yttrium monosilicate, and combinations thereof. In this embodiment, the intermediate barrier is a mixture of disilicate and monosilicate materials. Again, this mixture provides a transition layer between the substrate and the monosilicate topcoat. This mixed barrier may be compositionally graded, as described above, to further enhance the stress-reducing and stability-promoting advantages of having the mixed layer. For example, at the interface of the barrier with the bondcoat, the concentration of monosilicate is controlled to be at a minimum, and this concentration is controlled to gradually increase to a maximum level at the interface between the barrier and the monosilicate topcoat.

Embodiments of the present invention also include a method for protecting an article from a high temperature environment. The method comprises providing a substrate comprising silicon; disposing a bondcoat comprising silicon over the substrate; disposing an intermediate barrier over the bondcoat, the barrier comprising at least one layer, wherein the at least one layer comprises a rare-earth silicate and is substantially free of mullite; and disposing a topcoat over the intermediate barrier, the topcoat comprising a rare-earth monosilicate. All of the various coating layers in this and the other embodiments set forth herein are formed using any suitable process known in the art, including, for example, chemical vapor deposition, physical vapor deposition, thermal spray deposition, and plasma spray deposition. Suitable thickness ranges and candidate materials are the same as described above for the article embodiments.

Additionally, in certain embodiments the barrier is formed by an in-situ process. For example, a layer comprising a rare-earth monosilicate is deposited over the bondcoat, and then this layer is reacted, such as by heating, to form a disilicate in-situ. In particular embodiments, the reaction is accomplished by heating the monosilicate to a temperature of at least 1000° C. in an environment containing oxygen. This heat treatment is generally performed for at least 100 hours to allow at least some conversion of the monosilicate to disilicate, with longer times resulting in higher amounts of conversion. The result of this treatment is a layer rich in disilicate formed within the barrier close to the bondcoat, which as explained above promotes the overall chemical stability of the coating system.

### EXAMPLES

The following examples are intended to demonstrate exemplary embodiments of the present invention and are not to be considered as limiting the scope of the present invention in any way.

### Example 1

A coating system was applied to a SiC/SiC ceramic matrix composite (CMC) substrate by an air plasma spray technique. The CMC surface was prepared by grit-blasting with 36 grit SiC particles. First, a silicon bondcoat about 75 micrometers thick was applied to the substrate. Next, a yttrium disilicate (Y₂Si₂O₇) intermediate barrier about 125 micrometers thick was deposited on top of the bondcoat. Finally, a top coat of yttrium monosilicate(Y₂SiO₅) 125 micrometers thick was deposited on the intermediate barrier. The coated substrate was heat treated for 10 hours at 1300 C in static air. X-ray diffraction showed the top coat consisted of crystalline yttrium monosilicate and the intermediate layer consisted of crystalline yttrium disilicate.

### Example 2

The coating deposition process described in Example 1 was followed with one modification. The intermediate layer in this example contained a mixture of yttrium monosilicate and yttrium disilicate. After exposure for 500 hours at 2400 F in air, an oxide layer was observed to have grown on the bond coat surface due to silicon oxidation. SEM/EDX analysis confirms the grown oxide layer was pure silica, SiO₂. There was no evidence of chemical reaction between the silica layer and the intermediate layer, demonstrating excellent interlayer chemical compatibility.

### Example 3

Bulk pellets of barium strontium aluminosilicate (BSAS—a conventional EBC material), yttrium monosilicate, lutetium monosilicate, and ytterbium monosilicate were produced by cold pressing and sintering. The sintered samples were exposed to a water-vapor rich environment (90% H₂O-10% O₂ atmosphere) at 1315° C. for 100 hours. The BSAS samples lost weight due to interaction with steam and subsequent volatilization of silica in the form of gaseous silicon hydroxide. On the other hand, none of the rare earth monosilicate samples lost weight, suggesting that coatings made of these materials would show good stability in steam. XRD analysis revealed no loss of silica or rare earth oxide after steam exposure, confirming little, if any, reaction with steam.

While various embodiments are described herein, it will be appreciated from the specification that various combinations of elements, variations, equivalents, or improvements therein may be made by those skilled in the art, and are still within the scope of the invention as defined in the appended claims.

What is claimed is:

1. An article for use in a high temperature environment, comprising:
a substrate comprising silicon;
a bondcoat comprising silicon, said bondcoat disposed over said substrate;
an intermediate barrier disposed over said bondcoat, said barrier comprising at least one layer, wherein said at least one layer comprises a rare-earth silicate and is substantially free of mullite; and
a topcoat disposed over said intermediate barrier, said topcoat comprising a rare-earth monosilicate.

2. The article of claim 1, wherein said rare-earth silicate is a rare-earth monosilicate, a rare-earth disilicate, and combinations thereof.

3. The article of claim 2, wherein said rare-earth disilicate is at least one of lutetium disilicate, ytterbium disilicate, yttrium disilicate, and combinations thereof; and wherein said rare-earth monosilicate of said at least one layer is at least one of lutetium monosilicate, ytterbium monosilicate, yttrium monosilicate, and combinations thereof.

4. The article of claim 2, wherein said barrier comprises a single layer.

5. The article of claim 4, wherein said single layer comprises a compositional gradient, wherein a concentration of said monosilicate increases as a function of distance in a direction away from said substrate toward said topcoat.

6. The article of claim 5, wherein said single layer further comprises said rare-earth disilicate.

7. The article of claim 2, wherein said barrier comprises a plurality of layers.

8. The article of claim 7, wherein said barrier comprises
a first layer disposed over said bondcoat, and
a second layer disposed over said first layer and under said topcoat,
wherein said first layer comprises a rare-earth disilicate and said second layer comprises a rare-earth monosilicate and a rare-earth disilicate.

9. The article of claim 8, wherein said first layer consists essentially of a rare-earth disilicate and said second layer consists essentially of a rare-earth monosilicate and a rare-earth disilicate.

10. The article of claim 8, wherein said second layer comprises a compositional gradient, wherein a concentration of said monosilicate increases as a function of distance in a direction away from said substrate toward said topcoat.

11. The article of claim 1, wherein a difference between a coefficient of thermal expansion of said substrate and a coefficient of thermal expansion of each layer of said barrier is up to about 3.0×10⁻⁶ ° C.⁻¹.

12. The article of claim 11, wherein said difference is up to about 0.5×10⁻⁶ ° C.⁻¹.

13. The article of claim 1, wherein said at least one layer has a thickness of up to about 250 micrometers.

14. The article of claim 13, wherein said thickness is in the range from about 25 micrometers to about 125 micrometers.

15. The article of claim 14, wherein said thickness is in the range from about 25 micrometers to about 75 micrometers.

16. The article of claim 15, wherein said at least one layer consists essentially of said rare-earth silicate.

17. The article of claim 1, wherein said topcoat has a thickness of up to about 750 micrometers.

18. The article of claim 17, wherein said thickness is in the range from about 25 micrometers to about 125 micrometers.

19. The article of claim 18, wherein said thickness is in the range from about 25 micrometers to about 75 micrometers.

20. The article of claim 1, wherein said topcoat comprises at least one of lutetium monosilicate, ytterbium monosilicate, yttrium monosilicate, and combinations thereof.

21. The article of claim 1, wherein said topcoat consists essentially of said rare-earth monosilicate.

22. The article of claim 1, wherein said bondcoat layer has a thickness in the range from about 25 micrometers to about 200 micrometers.

23. The article of claim 1, wherein said bondcoat comprises at least one of elemental silicon and a silicide.

24. The article of claim 1, wherein said substrate comprises at least one of silicon nitride, molybdenum disilicide, and silicon carbide.

25. The article of claim 24, wherein said substrate comprises a ceramic matrix composite material.

26. The article of claim 25, wherein said composite comprises a matrix phase and a reinforcement phase, and wherein said matrix phase and said reinforcement phase comprise silicon carbide.

27. The article of claim 1, wherein said substrate comprises a component of a gas turbine assembly.

28. An article for use in a high temperature environment, comprising:
a substrate comprising silicon;
a bondcoat comprising silicon, said bondcoat disposed over said substrate;
an intermediate barrier, said barrier substantially free of mullite and comprising
a. a first layer disposed over said bondcoat and comprising at least one of lutetium disilicate, ytterbium disilicate, yttrium disilicate, and combinations thereof, and
b. a second layer disposed over said first layer, said second layer comprising at least one of lutetium disilicate, ytterbium disilicate, yttrium disilicate, and combinations thereof, and further comprising at least one of lutetium monosilicate, ytterbium monosilicate, yttrium monosilicate, and combinations thereof; and
a topcoat disposed over said intermediate barrier, said topcoat comprising at least one of lutetium monosilicate, ytterbium monosilicate, yttrium monosilicate, and combinations thereof.

29. An article for use in a high temperature environment, comprising:
a substrate comprising silicon;
a bondcoat comprising silicon, said bondcoat disposed over said substrate;
an intermediate barrier disposed over said bondcoat, said barrier comprising at least one layer, wherein said at least one layer is substantially free of mullite and comprises lutetium disilicate, ytterbium disilicate, yttrium disilicate, and combinations thereof, and further comprises at least one of lutetium monosilicate, ytterbium monosilicate, yttrium monosilicate, and combinations thereof; and
a topcoat disposed over said barrier layer, said topcoat comprising at least one of lutetium monosilicate, ytterbium monosilicate, yttrium monosilicate, and combinations thereof.

30. A method for protecting an article from a high temperature environment, said method comprising:
providing a substrate, said substrate comprising silicon;
disposing a bondcoat comprising silicon over said substrate;
disposing an intermediate barrier over said bondcoat, said barrier comprising at least one layer, wherein said at least one layer comprises a rare-earth silicate and is substantially free of mullite; and
disposing a topcoat over said intermediate barrier, said topcoat comprising a rare-earth monosilicate.

31. The method of claim 30, wherein disposing said barrier comprises disposing a layer comprising a rare-earth monosilicate over said bondcoat and reacting said monosilicate to form a rare-earth disilicate in-situ.

32. The method of claim 31, wherein reacting comprises heating said monosilicate to a temperature of at least 1000° C. in an environment comprising oxygen.

33. The method of claim 30, wherein disposing said barrier comprises depositing said at least one layer using at least one of chemical vapor deposition, physical vapor deposition, thermal spray deposition, and plasma spray deposition.

34. The method of claim 30, wherein said rare-earth silicate is at least one of lutetium disilicate, ytterbium disilicate, yttrium disilicate, and combinations thereof.

35. The method of claim 30, wherein disposing said topcoat comprises disposing a topcoat comprising a rare earth monosilicate.

36. The method of claim 35, wherein said rare-earth monosilicate comprises at least one of lutetium monosilicate, ytterbium monosilicate, yttrium monosilicate, and combinations thereof.
